(19) United States
(12) Patent Application Publication
(10) Pub. No.: US 2026/0109010 A1
(43) Pub. Date: Apr. 23, 2026

(54) SELF-ADJUSTING RATCHET WRENCH WITH LATERALLY PIVOTAL HANDLE

(71) Applicants: Christopher Perot, Kingwood, TX (US); Brennan Perot, Kingwood, TX (US)

(72) Inventors: Christopher Perot, Kingwood, TX (US); Brennan Perot, Kingwood, TX (US)

(21) Appl. No.: 19/365,075

(22) Filed: Oct. 21, 2025

Related U.S. Application Data
(60) Provisional application No. 63/833,053, filed on Oct. 21, 2024.

(51) Int. Cl. B25B 23/00; B25B 13/50

(52) U.S. Cl. CPC B25B 23/0028; B25B 13/505

(57) ABSTRACT

A spring loaded self-adjusting ratchet wrench having a laterally pivotal handle that allows a user to pivot the handle left or right from the center line of the jaws of the wrench and thereby allowing the jaws of the wrench to grip and rotate fasteners disposed flush up against walls, the ground, and other surface without any interference from the handle of the wrench against the wall, ground, or other surface.

### CROSS-REFERENCE TO RELATED APPLICATIONS

The present application claims benefit of U.S. Provisional Application No. 63/833,053, filed Oct. 21, 2024; all which is incorporated herein in its entirety and referenced thereto.

### BACKGROUND OF THE INVENTION

### Field of the Invention

This invention relates generally to ratchet wrenches, and, more particularly to a spring loaded self-adjusting ratchet wrench having a laterally pivotal handle that allows a user to pivot the handle left or right from the center line of the jaws of the wrench and thereby allowing the jaws of the wrench to grip and rotate fasteners disposed flush up against walls, the ground, and other surface without any interference from the handle of the wrench against the wall, ground, or other surface.

### Background Art

There are several patents that are directed toward various ratchet wrenches, the following are several examples.

Lundell, U.S. Pat. No. 2,684,607 discloses a swingable jaw wrench having a pair of jaws relatively movable about fixed axes so as to securely grip and turn or rotate a round or irregular shaped part such as round pipe, irregular shaped couplings, plugs, caps, etc., and rotate such parts to effect threaded engagement or disengagement with respect to other parts.

Woo, U.S. Pat. No. 5,251,518 discloses a pipe wrench comprising: a handle including an upper portion having a plurality of teeth and a disc shaped plate having a central bore; a pivotable member including a surface having a plurality of teeth and a right-angled corner; a ratchet gear integrally formed on the pivotable member, the rachet gear including a central bore; means disposed within the central bore of the rachet gear and the central bore of the handle, for joining the pivotable member to the upper portion of the handle so that the plurality of teeth on the pivotable member are opposed to the plurality of teeth on the upper portion of the handle; an engaging member having two ends, one end having an inclined surface which engages the rachet gear, and the second end including a handle; a housing supporting the engaging member on the upper portion of the handle; and a spring disposed within the housing for urging the inclined surface of the engaging member into contact with the rachet gear.

Barnes, U.S. Pat. No. 6,053,076 discloses a pivoting jaw pipe wrench having a fixed jaw including a plurality of discrete teeth, each for a different one of a plurality of pipes having different diameters. A pivotal jaw member having first and second jaw faces at an obtuse angle to one another is displaceable toward and away from the fixed jaw, whereby a pipe of given diameter to be gripped by the wrench is cradled between the first and second jaw surfaces and engaged by the one of the discrete teeth provided on the arcuate jaw for the pipe of given diameter.

Khachatoorain, U.S. Pat. No. 6,349,621 discloses a wrench for applying a force to a work piece comprising a handle having proximal and distal ends, top and bottom edges and a slot extending therethrough with a groove extending downward from the slot. A fixed jaw is mounted at the distal end of the handle having an inner, contact surface for contacting the work piece, and a moveable jaw is pivotally mounted at the distal end of the handle having an inner, contact surface for contacting the work piece. A spring is mounted in the handle having a distal end in contact with the moveable jaw for biasing the moveable jaw toward the fixed jaw. A slidable button is mounted on the top edge of the handle, with a spring mounted between the slidable button and the top edge of the handle. A connector is provided having a distal end fixedly attached to the moveable jaw and a proximal end fixedly attached to the slidable button by a pin. In operation, the pin rides in the slot and fits in the groove.

Chartier et al, U.S. Pat. Nos. 6,742,419 and 7,044,030 disclose a pivoting jaw pipe wrench having a fixed jaw including a plurality of discrete teeth, each for a different one of a plurality of pipes having different diameters, and a pivotal jaw member having first and second jaw faces at an obtuse angle to one another and displaceable toward and away from the fixed jaw, whereby a pipe of given diameter to be gripped by the wrench is cradled between the first and second jaw surfaces and engaged by the one of the discrete teeth provided on the arcuate jaw for the pipe of given diameter.

Dong, U.S. Pat. No. 7,096,764 discloses a pipe wrench comprising a main body for providing a handle; a fixed jaw coupled to the main body, the fixed jaw being formed by at least two arcing jaw faces that are congruent and extend away from the main body; an angled jaw pivotably coupled to the main body for interacting with the fixed jaw for clamping, the angled jaw having at least two substantially straight jaw faces which face the at least two arcing jaw faces at an angle to each other for providing a three-point grip in conjunction with the fixed jaw during clamping; and a pivot disposed on the main body adjacent to the fixed jaw for pivotably coupling the angled jaw to the main body, wherein the angle between the at least two substantially straight jaw faces of the angled jaw is obtuse and a radius of curvature of a first arc subtending the arcing jaw face proximal to the pivot is smaller than a radius of curvature of a second arc subtending the arcing jaw face distal to the pivot.

Cheng, U.S. Patent 9, 248,554 discloses an adjustable wrench, having a handle part, a curved jaw part, a linkage part, an adjusting element and a restoring element. The handle part comprises a toothed portion. The curved jaw part is pivotally connected to the handle part. When the adjusting element is pushed by an external force, the adjusting element further moves the linkage part simultaneously, and the linkage part pulls the curved jaw part to rotate so as to adjust a size of an opening between the curved jaw part and the toothed portion.

Chern, U.S. Published patent application No. 20190299371 discloses a pipe wrench structure with a secure positioning function which includes a main body, an engaging portion including a pivot point, an upper jaw and a lower jaw for performing an opening/closing operation, a pipe being placed between the upper and lower jaws while clamping the pipe; an elastic restoring member installed to the upper and lower jaws and configured to be corresponsive to the pivot point, and provided for providing a pressing force to the upper jaw; an auxiliary ratchet surface, disposed at the lower jaw; an arc ratchet surface, disposed on an inner side of the upper jaw opposite to the lower jaw, and being in form of concave arc surface without an included angle, and the curvature of the arc ratchet surface being greater than the external periphery of the pipe.

### SUMMARY OF THE INVENTION

The present invention is distinguished over the prior art in general, and these patents in particular by a spring loaded self-adjusting ratchet wrench having a laterally pivotal handle that allows a user to pivot the handle left or right from the center line of the jaws of the wrench and thereby allowing the jaws of the wrench to grip and rotate fasteners disposed flush up against walls, the ground, and other surface without any interference from the handle of the wrench against the wall, ground, or other surface.

Other objects of the invention will become apparent from time to time throughout the specification and claims as hereinafter related.

### BRIEF DESCRIPTION OF THE DRAWINGS

FIG. 1 is a side elevation of the spring loaded self-adjusting ratchet wrench with a laterally pivotal handle in accordance with the present invention shown with the handle aligned with the center line of the jaws of the wrench.

FIG. 2 is a top plan view of the of the spring loaded self-adjusting ratchet wrench with a laterally pivotal handle shown with the handle aligned with the center line of the jaws of the wrench.

FIG. 3 is a top plan view of the of the spring loaded self-adjusting ratchet wrench with a laterally pivotal handle shown the handle pivoted to extend angularly to the right of the center line of the jaws of the wrench allowing the user to wrench flush up against walls, the ground, and other surfaces.

FIG. 4 is a perspective view of the of the spring loaded self-adjusting ratchet wrench as seen from the underside with the laterally pivotal handle shown pivoted to extend angularly upward relative to the of the center line of the jaws of the wrench.

### DESCRIPTION OF THE PREFERRED EMBODIMENT

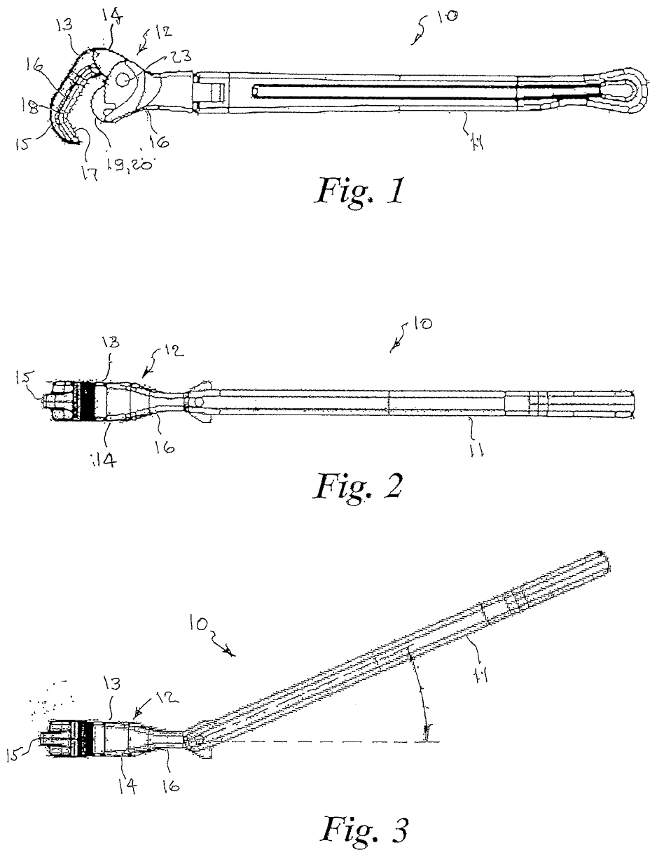

Referring now to the drawings by numerals of reference, there is shown in FIGS. 1, 2, 3, and 4, a preferred embodiment of the spring loaded self-adjusting ratchet wrench 10 that can be clamped onto a work piece with no adjustment required by the user and is particularly suited for use on nuts and bolts located in tight and difficult to reach areas.

The self-adjusting ratchet wrench 10 is made of steel construction and is comprised of two main parts, the wrench handle 11, and the wrench head 12. The wrench head 12 is pivotally connected on the wrench handle 11 with a bolt and three locking groves are machined into the male pivot point of the wrench head. These three locking groves allow the wrench head 12 to pivot laterally and lock 23.5 degrees to the left of the wrench handle 11, 0 degrees (the center of the wrench handle), and 23.5 degrees to the right of the wrench handle. It should be understood that the locking groves may be provided at different angles to lock the wrench head 12 at other angles to the left and right of the center line of the wrench handle 11.

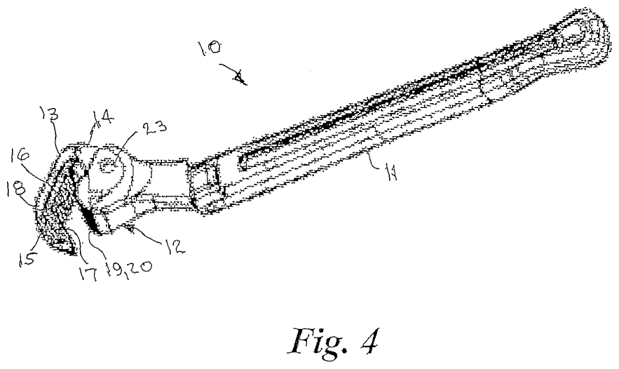

Two spring loaded ball bearings are located inside the female pivot point of the wrench handle 11 that lock into the locking groves on the wrench head 12. The tension of the spring locks the ball bearings into the wrench head 12, keeping the head locked in the desired position while wrenching. As best seen in FIGS. 3, and 4, The laterally pivotal handle 11 of the ratchet wrench 10 allows a user to pivot the handle left or right from the center line of the jaws of the wrench and thereby allowing the jaws of the wrench to grip and rotate fasteners disposed flush up against walls, the ground, or other surface without any interference from the handle of the wrench against the wall, ground, or other surface.

The wrench head 12 is of conventional construction and includes a pivotal jaw member 13 having a mounting end 14 and a jaw end 15 provided with first and second linear jaw faces having teeth 16 and 17, respectively. The toothed jaw faces 16 and 17 are disposed at an angle relative to one another which can be from 90° to 130° and are of standard shape and size for pipe wrenches, extend along the corresponding jaw face from a vertex 18 therebetween, and face inwardly of the front end 16 of handle 12.

A heel jaw member 19 is secured to the front end of the wrench handle 11. The heel jaw member 19 has an arcuate jaw face 20 comprising a plurality of teeth that extend laterally thereacross and face outwardly of the front end 16 of the wrench handle 11.

The front end of handle 12 includes laterally outwardly extending mounting arms 21 which are spaced apart to receive mounting end 22 of jaw member 19 therebetween, and the latter jaw member is pivotally mounted on handle 12 by a pin 23 extending therethrough and through mounting arms 21 and which provides a pivot axis for the jaw member 19.

A torsion spring (not shown) surrounds the pin 23 at the mounting end of jaw member 22 and has a pair of legs on opposite sides thereof engaging against a shoulder on the jaw member 19. The legs have central portions which circumscribe the pin 23, and the legs of the torsion spring terminate in ends that engage an interior surface of the handle 12 between at the mounting legs 36. Accordingly, it will be appreciated that the spring biases the jaw member 22 counterclockwise about axis of the pin 23 toward the closed position shown in FIGS. 1 and 4.

The pin and torsion spring arrangement surrounding the pin at the mounting end of the jaw member 22 is conventional and substantially similar to that shown in U.S. Pat. No. 7,044,030, which is incorporated by reference herein in its entirety.

While the present invention has been disclosed in various preferred forms, the specific embodiments thereof as disclosed and illustrated herein are considered as illustrative only of the principles of the invention and are not to be considered in a limiting sense in interpreting the claims. The claims are intended to include all novel and non-obvious combinations and sub-combinations of the various elements, features, functions, and/or properties disclosed herein. Variations in size, materials, shape, form, function and manner of operation, assembly and use, are deemed readily apparent and obvious to one skilled in the art from this disclosure, and all equivalent relationships to those illustrated in the drawings and described in the specification are intended to be encompassed in the following claims defining the present invention.

What is claimed is:

1. A spring loaded self-adjusting ratchet wrench comprising:
a wrench handle, and
a wrench head having gripping jaws pivotally connected to the wrench handle by pivot connection means configured to allow the wrench handle to pivot laterally relative to the wrench head; and
said connection means allow the gripping jaws of the wrench head to grip and rotate fasteners that are disposed flush up against a wall, the ground, or other surface without any interference from the wrench handle against the wall, ground, or other surface.

2. The spring loaded self-adjusting ratchet wrench according to claim 1 wherein:
said pivot connection means includes locking means configured to lock said wrench head at different angles relative to the center line of said wrench handle.

3. The spring loaded self-adjusting ratchet wrench according to claim 2 wherein: said locking means is configured selectively lock said wrench head at an angle of 23.5 degrees to the left of said wrench handle, the centerline of the wrench handle, and 23.5 degrees to the right of the wrench handle.
